(19) United States
(12) Patent Application Publication
(10) Pub. No.: US 2023/0324646 A1
(43) Pub. Date: Oct. 12, 2023

(54) CAMERA MODULE

(71) Applicant: Sharp Sensing Technology Corporation, Tenri City, Nara (JP)

(72) Inventors: Akihiro IIDA, Tenri City (JP); Yoshihito ISHIZUE, Tenri City (JP)

(21) Appl. No.: 17/971,625

(22) Filed: Oct. 23, 2022

(30) Foreign Application Priority Data
Mar. 22, 2022 (JP) 2022-045517

(51) Int. Cl. G02B 7/04; G03B 17/17

(52) U.S. Cl. CPC G02B 7/04; G03B 17/17

(57) ABSTRACT

A camera module includes a first lens barrel holding a first lens group, a second lens barrel holding a second lens group, and a lens driver holding the perimeter of the second lens barrel to move the second lens group in a direction along a first optical axis of the second lens group. The size of the lens driver in a direction intersecting with the first optical axis (302) is smaller than the size of the first lens barrel in the direction intersecting with the first optical axis.

### CROSS-REFERENCE TO RELATED APPLICATION

The present application claims priority from Japanese Application JP2022-045517, the content of which is hereby incorporated by reference into this application.

### BACKGROUND OF THE INVENTION

### 1. Field of the Invention

The present invention relates to a camera module that includes lenses that concentrate object light onto an image pickup unit, and a driver that drives the lenses in the direction along the optical axis of the lenses.

### 2. Description of the Related Art

A camera module of a whole-group extension type has been conventionally known (Japanese Patent No. 5611533) that includes a plurality of image pickup lenses for taking a subject’s image, a lens barrel holding the plurality of image pickup lenses, and a lens driver that drives the lens barrel, and the camera module extends the lens barrel holding this set of image pickup lenses.

Further, another camera module of the whole-group extension type has been known (U.S. Pat. No. 10371928) that includes a reflective element, such as a prism or mirror, that is anterior to a plurality of image pickup lenses in order to thin a smartphone incorporating the camera module, and the reflective element can incline the optical axis of light from a subject, from a direction perpendicularly to the smartphone’s backside to a direction parallel to the smartphone’s backside.

### SUMMARY OF THE INVENTION

Unfortunately, Japanese Patent No. 5611533 requires a clearance for the image pickup lenses to move in the direction along the optical axis by a length equal to the amount of extension in the whole-group extension type; hence, a camera module that includes a telephoto lens with a long focal length particularly involves a large amount of extension, thus upsizing the camera module and making it difficult to downsize and slim down the camera module.

Further, when the whole-group extension type is combined with a folding optical system in order to solve this problem, as described in U.S. Pat. No. 10371928, a clearance distance equal to or larger than the amount of whole-group lens extension in the lens driver is required between the lenses and the reflective element.

Light rays spread out by the field angle of the lenses in accordance with this clearance distance. The reflective element needs to be also upsized along with the light ray spread, thus increasing the thickness and footprint of the camera module as well.

Accordingly, an attempt to obtain a camera module of this type with a large amount of whole-group extension results in an upsized camera module similarly, and downsizing and thickness reduction are difficult to achieve.

One aspect of the present invention aims to achieve the downsizing and slimming down of a camera module.

To solve the above problem, a camera module according to one aspect of the present invention includes the following: a first lens barrel holding a first lens group, the first lens group including two or more lenses, having a positive power as a whole, and being configured to receive object light; a second lens barrel holding a second lens group, the second lens group including one or more lenses, having a negative power as a whole, and disposed in a traveling direction of the object light with respect to the first lens group to concentrate the object light; and a lens driver holding the perimeter of the second lens barrel to move the second lens group in a direction along a first optical axis of the second lens group, wherein the size of the lens driver in a direction intersecting with the first optical axis is smaller than the size of the first lens barrel in the direction intersecting with the first optical axis.

The aspect of the present invention can downsize and slim down a camera module.

### BRIEF DESCRIPTION OF THE DRAWINGS

FIG. 1 is a perspective view of a camera module according to a first preferred embodiment;

FIG. 2 is a sectional view taken along line A-A in FIG. 1;

FIG. 3 is a sectional view of a lens driver in FIG. 2 taken along a plane including an optical axis;

FIG. 4 illustrates a configuration of an optical unit provided in a camera module according to a second preferred embodiment;

FIG. 5 is a sectional perspective view taken along line B-B in FIG. 4;

FIG. 6 is a perspective view of a camera module according to a third preferred embodiment with a first lens barrel mounted on a case;

FIG. 7 is a perspective view of a camera module according to a comparative example;

FIG. 8 is a sectional view taken along line C-C in FIG. 7; and

FIG. 9 is a perspective view of a camera module according to another comparative example.

### DETAILED DESCRIPTION OF THE INVENTION

### First Preferred Embodiment

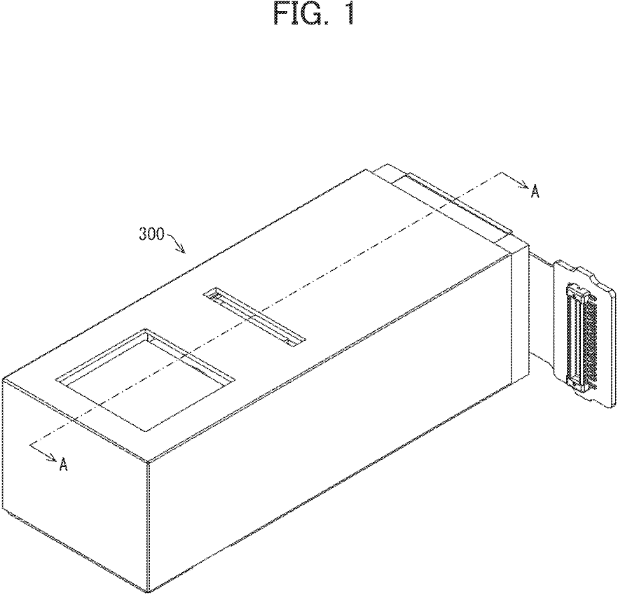

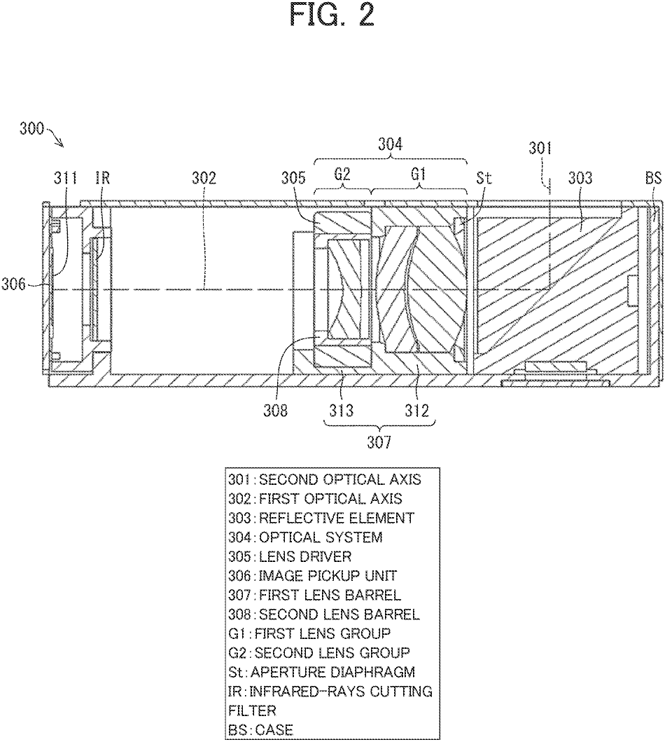

One preferred embodiment of the present invention will be detailed. FIG. 1 is a perspective view of a camera module 300 according to a first preferred embodiment. FIG. 2 is a sectional view taken along line A-A in FIG. 1 and corresponds to a sectional view of the camera module 300 with its middle part cut in a direction along an optical axis.

The camera module 300 includes an optical system 304, and an image pickup unit 306 having an image formation surface 311 that concentrates object light that has passed through the optical system 304, and configured to subject the object light to photoelectric conversion.

The optical system 304 includes the following: a first lens group G1 including two or more lenses, having a positive power as a whole, and configured to receive object light; a second lens group G2 including one or more lenses, having a negative power as a whole, and being posterior to the first lens group G1 to concentrate the object light; and a lens driver 305 configured to move the second lens group G2 in a direction along a first optical axis 302.

The camera module 300 further includes a first lens barrel 307 holding the perimeter of the first lens group G1, and a second lens barrel 308 holding the perimeter of the second lens group G2. The lens driver 305 holds the perimeter of the second lens barrel 308.

The size of the lens driver 305 in a direction perpendicular to the first optical axis 302 is smaller than the size of the first lens barrel 307 in the direction perpendicular to the first optical axis 302.

The first lens barrel 307 has the following: a lens holding part 312 formed so as to surround the perimeter of the first lens group G1; and a driver incorporating part 313 extending along the first optical axis 302 from the lens holding part 312 to incorporate the lens driver 305.

Moreover, the camera module 300 further includes a reflective element 303 anterior to the first lens group G1 of the optical system 304. The reflective element 303 guides object light emitted along a second optical axis 301 to the optical system 304 along the first optical axis 302. The optical system 304 concentrates the object light on the image formation surface 311 along the first optical axis 302.

The first lens group G1 and the image pickup unit 306 are fastened to the case BS so that the distance between the first lens group G1 and image pickup unit 306 in a direction along the first optical axis 302 does not vary in focusing on a close-range object that emits object light.

The camera module 300 according to the first preferred embodiment includes the following, as illustrated in FIG. 2: the reflective element 303 disposed closest to a subject and configured to guide, along the first optical axis 302, light from a subject and along the second optical axis 301; the optical system 304 posterior to the reflective element 303; and the image pickup unit 306 configured to subject light that has passed through the optical system 304 to photoelectric conversion.

The optical system 304 includes the first lens group G1 located closest to the reflective element 303, the second lens group G2 posterior to the first lens group G1, and the lens driver 305 configured to move the second lens group G2 in a direction substantially coinciding with the first optical axis 302.

Further, the camera module 300 further includes an aperture diaphragm St incorporated in the optical system 304, an infrared-rays cutting filter IR disposed forward of the image pickup unit 306, and the case BS supporting all the foregoing components directly or indirectly.

The reflective element 303 bends light rays that travel along the second optical axis 301 from a subject, guides the light rays along the first optical axis 302 and transmits the light rays to the optical system 304. Although the angle at which the reflective element 303 bends the light rays, that is, the angle between the first optical axis 302 and the second optical axis 301 is preferably 90 degrees, the angle can be changed as appropriate and is not limited to 90 degrees.

Further, although various reflective materials, including a prism and a reflective plate (mirror), can be used as appropriate for the reflective element 303, a prism is preferably used in view of processing accuracy.

Furthermore, the reflective element 303, which is supported by the case BS of the camera module 300, can achieve the function of optical hand-induced-shake correction, as described later on, by the provision of a driving mechanism between the reflective element 303 and the case BS.

The optical system 304 concentrates the light rays guided along the first optical axis 302 by the reflective element 303 onto the image formation surface 311 of the image pickup unit 306 to form an image.

The optical system 304, which includes the first lens group G1, the second lens group G2, and the aperture diaphragm St and is supported by the case BS, can achieve the function of optical hand-induced-shake correction, as described later on, by the provision of a driving mechanism between the optical system 304 and the case BS.

The lens driver 305 drives the second lens group G2 in a direction substantially coinciding with the second optical axis 301 to perform focusing.

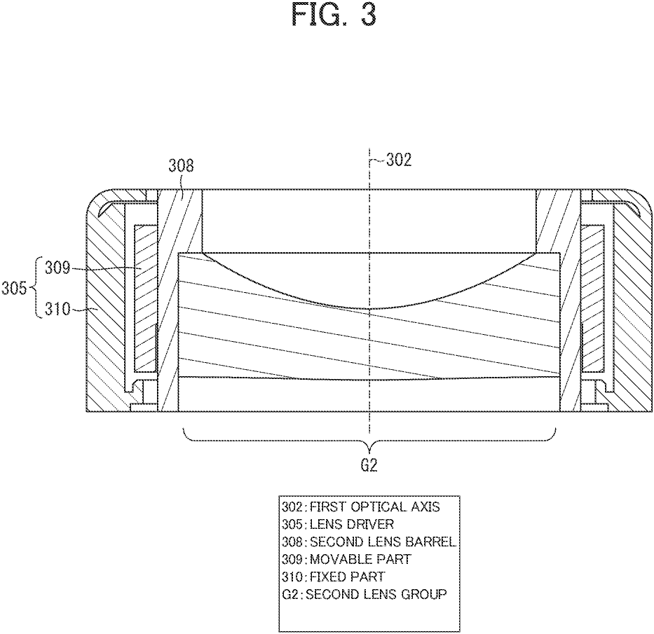

FIG. 3 is a sectional view of the lens driver 305 in FIG. 2 taken along a plane including an optical axis.

The lens driver 305 includes a movable part 309 holding the perimeter of the second lens barrel 308, and a fixed part 310 disposed on the outside of the movable part 309 and designed not to change position when the second lens barrel 308 undergoes driving. Displacing the movable part 309 along the first optical axis 302 with respect to the fixed part 310 can adjust the position of the second lens group G2 in the direction along the first optical axis 302.

For the lens driver 305, various apparatuses are known, such as an apparatus that includes a stepping motor, an apparatus that includes a piezoelectric element, and an apparatus that includes a VCM, and the lens driver 305 does not have to be limited to any of them. Nevertheless, the lens driver 305 desirably includes a VCM in view of size, performance and price.

The optical system 304 concentrates light rays guided along the first optical axis 302 by the reflective element 303 onto the image pickup unit 306 to form an image.

The image pickup unit 306 is a sensor device that converts, through photoelectric conversion, light rays concentrated on the image formation surface 311 by the optical system 304 into electric signals. The electric signals undergo software processing and are finally output to an image.

The image pickup unit 306 can achieve the function of optical hand-induced-shake correction, as described later on, by the provision of a driving mechanism between the image pickup unit 306 and the case BS.

The infrared-rays cutting filter IR has the function of blocking infrared rays contained in light that enters the image pickup unit 306.

Further, if a foreign substance (dust) attaches to the image pickup unit 306 directly, the convergence of light is hindered, degrading an image seriously; hence, the infrared-rays cutting filter IR is provided forward of the image pickup unit 306 and thus has the function of reducing the risk of direct attachment of a foreign substance to the image pickup unit 306.

It is noted that the camera module 300 according to this preferred embodiment can offer a configuration that achieves optical hand-induced-shake correction by rotating the reflective element 303 about any two axes.

The foregoing configuration includes the following: a shake detecting means for detecting a hand-induced shake; a controller that controls a driving part for the reflective element 303 on the basis of a signal sent from the shake detecting means; the driving part for rotating the reflective element 303; and a retainer holding the reflective element 303 and configured to propagate the operation of the driving part to move the reflective element 303.

Alternatively, the camera module 300 according to this preferred embodiment can offer a configuration that achieves optical hand-induced-shake correction by moving the optical system 304 in parallel with any two axes.

The foregoing configuration includes the following: a shake detecting means for detecting a hand-induced shake; a controller that controls a driving part for the optical system 304 on the basis of a signal sent from the shake detecting means; the driving part for moving the optical system 304; and a retainer holding the optical system 304 and configured to propagate the operation of the driving part to move the optical system 304.

Further alternatively, the camera module according to this preferred embodiment can offer a configuration that achieves optical hand-induced-shake correction by moving the image pickup unit 306 in parallel with any two axes.

The foregoing configuration includes the following: a shake detecting means for detecting a hand-induced shake; a controller that controls a driving part for the image pickup unit 306 on the basis of a signal sent from the shake detecting means; the driving part for moving the image pickup unit 306; and a retainer holding the image pickup unit 306 and configured to propagate the operation of the driving part to move the image pickup unit 306.

Any of these configuration achieves optical hand-induced-shake correction through driving of two axes of constituent components; thus, combining the driving direction of one component and the driving direction of another component together, e.g., one axis for the rotation axis of the reflective element 303, and another axis for the movement axis of the optical system 304, can also achieve optical hand-induced-shake correction.

These configurations that achieve optical hand-induced-shake correction are known commonly, and their detailed description and illustration will be thus omitted.

### Second Preferred Embodiment

Another preferred embodiment of the present invention will be described. It is noted that for convenience in description, components having the same functions as components described in the foregoing preferred embodiment will be denoted by the same signs, and their description will not be repeated.

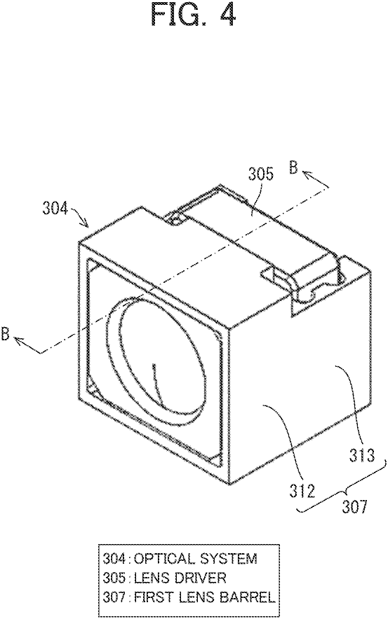

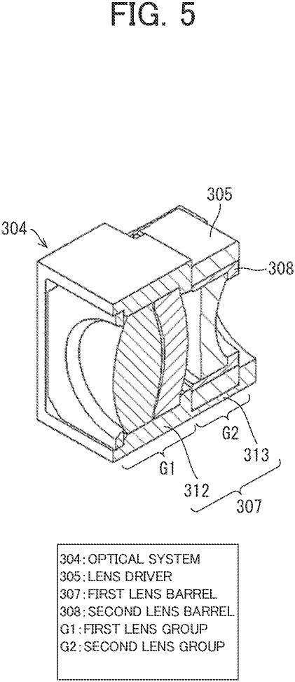

FIG. 4 illustrates a configuration of the optical system 304 provided in a camera module according to a second preferred embodiment. FIG. 5 is a sectional perspective view taken along line B-B in FIG. 4 and corresponds to a sectional perspective view of the optical system 304 with its middle part cut in a direction along an optical axis.

By the way, a typical whole-group extension type needs to be shaped in such a manner that the size of its lens driver in a direction intersecting with the optical axis conforms to the maximum diameter of all the lenses, and the lens driver needs to be upsized in order to obtain a stable driving force for driving all the lenses in the group; thus, the specifications of the lens driver are highly important for determining camera module size.

Further, a lens with a long focal length such as a telephoto lens has a small angle of field; hence, the optically effective diameter of a lens located close to a target imaging object is larger than the optically effective diameter of a lens located close to an image pickup element. That is, the diameter of the first lens group G1 is typically larger than the diameter of the second lens group G2 located close to the image pickup element.

In the configuration according to this preferred embodiment, the lenses held by the lens driver 305 belong to only the second lens group G2, thus enabling the lens driver 305 to be smaller than that of a typical whole-group extension type.

Accordingly, the lens driver 305 according to this preferred embodiment has the following feature: the size of the fixed part 310 of the lens driver 305 in a direction perpendicular to the first optical axis 302 is smaller than the size of the first lens barrel 307 in the direction perpendicular to the first optical axis 302. In other words, the size of the camera module according to this preferred embodiment is not affected by the size of the lens driver 305.

In an example applied configuration, the lens driver 305 can be incorporated into the first lens barrel 307. To be specific, the lens driver 305 can be incorporated into the driver incorporating part 313 of the first lens barrel 307.

The foregoing configuration, which enables the optical system 304 to be a one-piece optical unit, offers advantages in production, including the simplification of production and of performance evaluation by the use of only the optical system 304. In another applied configuration, assembling the first lens barrel 307 and the lens driver 305 separately as individual components can also offer advantages in production.

For instance, the image pickup unit 306 and the lens driver 305 incorporating the second lens group G2 are firstly assembled to the case BS, and the first lens barrel 307 incorporating the first lens group G1 is thereafter assembled to the case BS.

At this time, outputting information about imaging by the use of the image pickup unit 306 enables the assembly of the first lens barrel 307 of the optical system 304 while adjusting an assembly position in which the quality of imaging is the highest in the assembly of the first lens barrel 307.

Furthermore, the lens driver 305 and the case BS can be used as a one-piece component; in this case, the second lens barrel 308 incorporating the second lens group G2 is assembled to the one-piece component consisting of the lens driver 305 and case BS. The foregoing configuration can offer a simplified lens driver and can reduce assembled components.

The order of assembly can be reversed as a matter of course; that is, the first step is assembling the image pickup unit 306 and the first lens barrel 307 incorporating the first lens group G1 to the case BS, and the next step is assembling the optical system 304 to the case BS while adjusting an assembly position for the lens driver 305 incorporating the second lens group G2.

### Third Preferred Embodiment

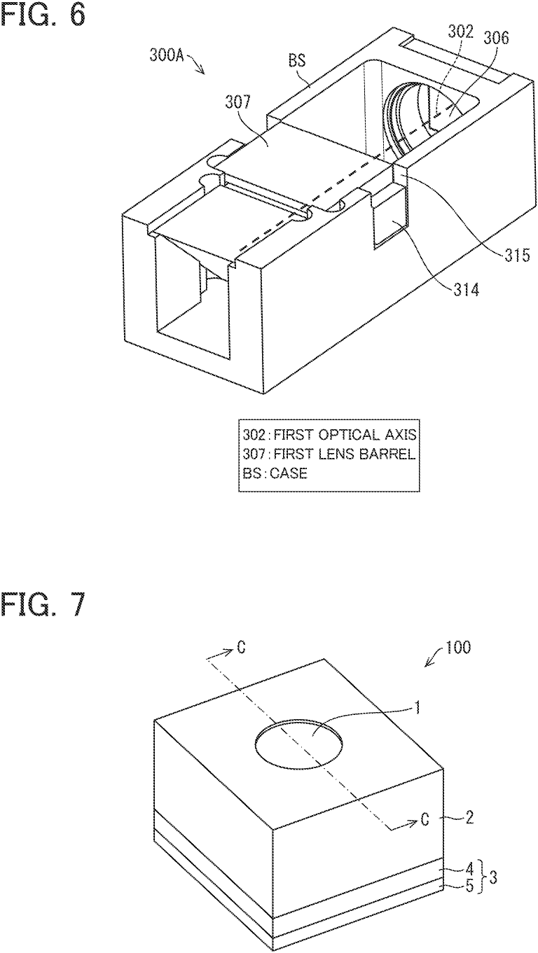

FIG. 6 is a perspective view of a camera module according to a third preferred embodiment with the first lens barrel 307 assembled to the case BS.

A camera module 300A according to the third preferred embodiment of the present invention features, as illustrated in FIG. 6, that the first lens barrel 307 has a protrusion structure 314, that the case BS has a guidance structure 315 for receiving the protrusion structure 314, and that the position of the first lens barrel 307 in the direction along the first optical axis 302 with respect to the image pickup unit 306 is fixed by the protrusion structure 314 and the guidance structure 315.

The first lens barrel 307 includes a bottom surface, a pair of side surfaces protruding from both ends of the bottom surface, and a top surface coupling the pair of side surfaces together. Moreover, a pair of protrusion structures 314 protrudes outward from the pair of side surfaces.

The case BS includes a bottom surface, and a pair of side surfaces protruding from both ends of the bottom surface. The pair of side surfaces has a pair of guidance structures 315 cut so as to be fitted in the pair of respective protrusion structures 314.

It is noted that the protrusion structures 314 may be provided in the case BS; in this case, the guidance structures 315 are provided in the first lens barrel 307.

The foregoing configuration can facilitate the positional adjustment of the first lens group G1 in the direction along the first optical axis 302.

### Comparative Example

FIG. 7 is a perspective view of a camera module 100 according to a comparative example. The camera module 100 is a camera module of a straight type described in Japanese Patent No. 5611533. The camera module 100 is composed of the following: an optical unit 1, which is an image-pickup optical system; a lens driver 2 configured to drive the optical unit 1; and an image pickup unit 3 configured to subject light that has passed through the optical unit 1 to photoelectric conversion. The optical unit 1 is held inside the lens driver 2. The image pickup unit 3 is composed of a sensor 4, and a substrate 5 on which the sensor 4 is mounted. The camera module 100 is configured such that the sensor 4 and the lens driver 2 are stacked on the substrate 5 in this order in a direction along an optical axis. For convenience, a side where the optical unit 1 is located will be hereinafter referred to as top, and a side where the image pickup unit 3 is located will be hereinafter referred to as bottom.

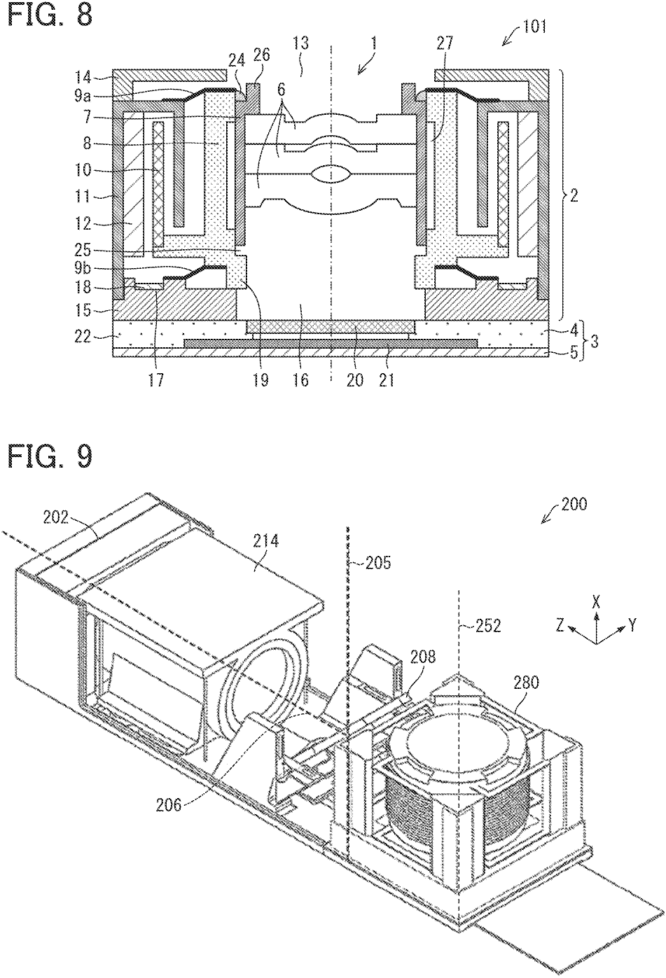

FIG. 8 is a sectional view taken along line C-C in FIG. 7. The following describes the overall structure of the camera module 100 on the basis of FIG. 8. FIG. 8 is a sectional view of the camera module 100 with its middle part cut in a direction along an optical axis.

The optical unit 1 is an image-pickup optical system that forms an image of a subject and guides external light to the sensor 4 of the image pickup unit 3. The optical unit 1 is composed of a plurality of image pickup lenses 6 (three image pickup lenses 6 in FIG. 8), and a lens barrel 7 holding the image pickup lenses 6. The lens barrel 7 is fastened to the lens driver 2.The optical axis of the image pickup lenses 6 coincides with the axial core of the lens barrel 7.

The lens driver 2, which is operated by a voice coil motor (VCM), is mounted on the camera module 100. The lens driver 2 drives the optical unit 1 in the direction along the optical axis with an electromagnetic force. That is, the lens driver 2 raises or lowers the image pickup lenses 6 between the infinity end and the macro end. The camera module 100 accordingly exerts its auto-focus function. Such a type in which the lens barrel 7 holding the set of image pickup lenses 6 is extended is called a whole-group extension type.

The lens driver 2 includes the following: a movable part configured to move in the direction along the optical axis for moving the optical unit 1 (image pickup lenses 6) in the direction along the optical axis when the image pickup lenses 6 undergo driving; and a fixed part that does not change position when the image pickup lenses 6 undergo driving. The movable part is housed within the fixed part. The movable part is composed of a lens holder 8 and a coil 10, and the fixed part is composed of a yoke 11, a permanent magnet 12, a cover 14, and a base 15.

The coil 10 is fastened to the outer end (flange) of the lens holder 8. The coil 10 extends from the outer end (bottom) of the lens holder 8 toward the incidence of light (toward an opening 13, which will be described later on).

The base 15 constitutes the bottom of the lens driver 2 and has a back surface on which the sensor 4 is provided. The base 15 has, in its middle part, an opening 16 bored to establish an optical path.

The yoke 11 is a pipe-shaped member and constitutes the side surface of the lens driver 2. The yoke 11 houses the movable part. The yoke 11 is fastened on the base 15. The cover 14 is provided above the yoke 11. The cover 14 constitutes the upper part (top surface) of the lens driver 2.

The yoke 11 has an inner side surface on which a magnetic circuit composed of the permanent magnet 12 is disposed so as to face the coil 10.

The lens driver 2 drives the image pickup lenses 6 in the direction along the optical axis with an electromagnetic force generated by the coil 10 and permanent magnet 12. To be specific, in this preferred embodiment, feeding a current through the coil 10 within a magnetic field formed by the permanent magnet 12 produces a force, with which the image pickup lenses 6 (lens holder 8) can be driven in the direction along the optical axis.

Further, the lens driver 2 has plate springs 9a and 9b provided on the upper and lower surfaces (top and bottom surfaces) of the lens holder 8. The plate springs 9a and 9b press the lens holder 8 in the direction along the optical axis. That is, the plate springs 9a and 9b support the lens holder 8 accessorily with their elastic force in such a manner that the lens holder 8 can move in the direction along the optical axis. The plate springs 9a and 9b have a spiral pattern. Each of the plate springs 9a and 9b needs to be fasted to the movable part at one of its ends and needs to be fastened to the fixed part at the other end.

When the camera module 100 remains assembled, the lens holder 8 is pressurized downward by the elastic force of the plate springs 9a and 9b with a protrusion 19, formed on the bottom surface of the lens holder 8, being in contact with the base 15, as illustrated in FIG. 8.

The thickness of the camera module 100 of the aforementioned conventional straight type is specified based on the optical length between the lens distal end and the surface of an image pickup element, based on the thicknesses of the image pickup element, of a substrate and of other things, and based on the amount of whole-group extension of lenses for focusing. An addition of the optical length and the amount of whole-group extension will be referred to as an optical overall length.

The foregoing optical length is commonly proportional to a focal length (angle of field), and the foregoing amount of whole-group extension of the lenses is commonly roughly proportional to the square of a focal length, as indicated by the following expressions:

$$\text{1 / a + 1 / b = 1 / f} ⇒ \text{b = af / (a - f), and}$$

$${\text{d = b - f = f}}^{2} \text{(a-f), where f <<a} \text{.}$$

Here, a denotes the distance from the principal points of lenses to a subject, b denoted the distance from the principal points of the lenses to the image formation surface, f denotes an actual focal length, and d denotes the amount of whole-group extension of the lenses necessary for focusing from infinity onto a position a.

The camera module 100 of the conventional straight structure for instance, includes a wide-angle lens mainly and has a 35 mm-equivalent focal length of 25 mm. For a sensor of a ½ type, the optical length measures 5 mm, and the amount of whole-group extension for 10 cm focusing measures about 0.2 mm on the basis of the forgoing expressions.

By the way, modern commercialized multi-lens or multi-camera-equipped electronic apparatuses, such as smartphones, incorporate a plurality of camera modules. These electronic apparatuses are equipped with camera modules each including a wide-angle camera as well as a super-wide-angle or telephoto lens, and in combination with digital correction, the apparatuses offer such usability as that of a zoom camera to a user.

For a twin-lens camera with a zoom factor of 4×, the telephoto side uses an optical system with a telephoto-side 35 mm-equivalent focal length of 100 mm when the wide-angle side has a 35 mm-equivalent focal length of 25 m. A sensor of the ½ type has an optical length of 19 mm and an amount of whole-group extension of about 4.2 mm and thus has a module thickness equal to or greater than about four times of a camera that includes a sensor of the same size. The size of a sensor is often reduced on the telephoto side; a sensor of a ¼ type has an optical length of 10 mm and an amount of whole-group extension of about 1.2 mm and thus has a twice or more thickness.

Accordingly, to reduce the thickness of this camera module on the telephoto side, a camera module structure for a folding optical system like one in FIG. 9 has been proposed. FIG. 9 is a perspective view of a camera module 200 according to another comparative example.

This folding camera module 200 includes a reflective element 208, such as a prism or a mirror, as illustrated in FIG. 9, and can incline the direction along the optical axis from a direction 205, which is perpendicular to the smartphone’s backside, toward a direction 206, which is parallel to the smartphone’s backside.

However, when a whole-group extension type and a folding optical system are combined in the camera module 200 shown in FIG. 9, a clearance distance equal to or larger than the amount of whole-group extension of a lens barrel 214 in its lens driver is required between the lens barrel 214 and the reflective element 208. Light rays spread out by the field angle of the lenses in accordance with this clearance distance. The reflective element 208 needs to be also upsized along with the light ray spread, thus increasing the thickness and footprint of the camera module 200 as well.

Thus, an attempt to obtain a lens driver with a large amount of whole-group extension results in upsizing of the camera module 200 and difficulty in downsizing and thickness reduction.

Lens driver upsizing leads to power consumption increase, affecting the battery duration of an electronic apparatus equipped with the camera module 200, terminal downsizing, and by extension, battery cost.

Further, a VCM-operated lens driver, whether it is a straight type or a folding type, is typically structured such that the movable part of the lens driver is supported by springs. Accordingly, spring resilience increases along with increase in focal length and in the amount of whole-group extension. Consequently, a considerable thrust is required, and the amount of spring deformation increases, thereby causing problems, such as a serious spring distortion. A spring distortion causes the driving axis of the lens driver to incline with respect to the optical axis; an inclined optical system induces degradation in the quality of a taken image.

In contrast to this, the optical system 304 of the camera module 300 according to the first to third preferred embodiments is configured such that the first lens group G1, which includes two or more lenses, has a positive power as a whole and configured to receive object light, and the second lens group G2, which includes one or more lenses, has a negative power as a whole and is posterior to the first lens group G1 to concentrate the object light on the image pickup unit, satisfy the following conditional expressions:

$$- 6.0 < \text{f} / \text{f2} < - 2.0 \qquad \text{Conditional Expression (1),}$$

$$\text{ih} / \text{f} < 0.4 \qquad \text{Conditional Expression (2),}$$

$$0.7 < \text{TTL} / \text{f} < 1.0 \qquad \text{Conditional Expression (3),}$$

$$1.6 < \text{Fno} < 7.0 \qquad \text{Conditional Expression (4),}$$

and

$$\text{De2} < \text{De1} \qquad \text{Conditional Expression (5).}$$

Thus, moving the second lens group G2 in a direction along the first optical axis 302 enables focusing on a close-range object that emits object light. This eliminates the need for using a whole-group extension type; extending only the second lens group G2 enables the foregoing focusing. The optical system 304 and the camera module 300 can be consequently downsized and slimmed down.

### Summary

A camera module 300, 300A according to a first aspect of the present invention includes the following: a first lens barrel 307 holding a first lens group G1, the first lens group including two or more lenses, having a positive power as a whole, and being configured to receive object light; a second lens barrel 308 holding a second lens group G2, the second lens group including one or more lenses, having a negative power as a whole, and disposed in a traveling direction of the object light with respect to the first lens group G1 to concentrate the object light; and a lens driver 305 holding the perimeter of the second lens barrel 308 to move the second lens group G2 in a direction along a first optical axis 302 of the second lens group, wherein the size of the lens driver 305 in a direction intersecting with the first optical axis 302 is smaller than the size of the first lens barrel 307 in the direction intersecting with the first optical axis 302.

The foregoing configuration can reduce the size of the lens driver in the direction intersecting with the first optical axis. The camera module can be thus downsized when compared with a typical whole-group extension type.

The camera module 300, 300A according to a second aspect of the present invention is preferably configured, in the first aspect, such that the lens driver 305 is incorporated in the first lens barrel 307.

The foregoing configuration, which enables an optical system to be a one-piece optical unit, offers advantages in production, including the simplification of production and of performance evaluation by the use of only the optical system.

In the first aspect, the camera module 300, 300A according to a third aspect of the present invention preferably further includes an image pickup unit 306 to which the object light converges, and the position of the first lens barrel 307 with respect to the image pickup unit 306 is preferably fixed.

The foregoing configuration can facilitate the positional adjustment of the first lens group in the direction along the first optical axis.

In the first aspect, the camera module 300A according to a fourth aspect of the present invention preferably further includes a case BS housing the first lens barrel 307. The camera module 300A is preferably configured such that one of the first lens barrel 307 and the case BS is provided with a protrusion structure 314 protruding in the diameter direction of the first lens barrel 307, and that the other one of the first lens barrel 307 and the case BS is provided with a guidance structure 315 for the protrusion structure 314.

The foregoing configuration enables the position of the first lens barrel to be fixed with respect to the image pickup unit.

The camera module 300, 300A according to a fifth aspect of the present invention is preferably configured, in the first aspect, such that the lens driver 305 has a movable part 309 configured to move for moving the second lens group G2 in the direction along the first optical axis 302, and a fixed part 310 that does not change position when the second lens group G2 undergoes movement, and such that the size of the fixed part 310 in the direction intersecting with the first optical axis 302 is smaller than the size of the first lens barrel 307 in the direction intersecting with the first optical axis 307.

The foregoing configuration can reduce the size of the fixed part of the lens driver in the direction intersecting with the first optical axis.

In the first aspect, the camera module 300, 300A according to a sixth aspect of the present invention preferably further includes a reflective element 303 disposed in a direction opposite to the traveling direction of the object light with respect to the first lens group G1. The camera module 300, 300A is preferably configured such that the reflective element 303 guides, along the first optical axis 302, the object light emitted along a second optical axis 301 intersecting with the first optical axis 302, and such that the first lens group G1 and the second lens group G2 concentrate the object light along the first optical axis 302.

The foregoing configuration, which can achieve a camera module structure for a folding optical system and can incline the direction along the optical axis from a direction perpendicular to the smartphone’s backside toward a direction parallel to the smartphone’s backside, is suitable in the present invention.

The present invention is not limited to the foregoing preferred embodiments. Various modifications can be devised within the scope of the claims. A preferred embodiment that is obtained in combination, as necessary, with the technical means disclosed in the respective preferred embodiments is also included in the technical scope of the present invention. Furthermore, combining the technical means disclosed in the respective preferred embodiments can form a new technical feature.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A camera module comprising:
a first lens barrel holding a first lens group, the first lens group including two or more lenses, having a positive power as a whole, and being configured to receive object light;
a second lens barrel holding a second lens group, the second lens group including one or more lenses, having a negative power as a whole, and disposed in a traveling direction of the object light with respect to the first lens group to concentrate the object light; and
a lens driver holding a perimeter of the second lens barrel to move the second lens group in a direction along a first optical axis of the second lens group,
wherein a size of the lens driver in a direction intersecting with the first optical axis is smaller than a size of the first lens barrel in the direction intersecting with the first optical axis.

2. The camera module according to claim 1, wherein the lens driver is incorporated in the first lens barrel.

3. The camera module according to claim 1, further comprising an image pickup unit to which the object light converges,
wherein a position of the first lens barrel with respect to the image pickup unit is fixed.

4. The camera module according to claim 1, further comprising a case housing the first lens barrel,
wherein one of the first lens barrel and the case is provided with a protrusion structure protruding in a diameter direction of the first lens barrel, and
another one of the first lens barrel and the case is provided with a guidance structure for the protrusion structure.

5. The camera module according to claim 1, wherein
the lens driver has a movable part configured to move for moving the second lens group in the direction along the first optical axis, and a fixed part that does not change position when the second lens group undergoes movement, and
a size of the fixed part in the direction intersecting with the first optical axis is smaller than a size of the first lens barrel in the direction intersecting with the first optical axis.

6. The camera module according to claim 1, further comprising a reflective element disposed in a direction opposite to the traveling direction of the object light with respect to the first lens group,
wherein the reflective element guides, along the first optical axis, the object light emitted along a second optical axis intersecting with the first optical axis, and
the first lens group and the second lens group concentrate the object light along the first optical axis.
